(19) United States
(12) Patent Application Publication
(10) Pub. No.: US 2019/0211245 A1
(43) Pub. Date: Jul. 11, 2019

(54) SURFACE-MODIFIED COLLOIDAL CERIA ABRASIVE PARTICLES, PREPARATION METHOD THEREFOR, AND POLISHING SLURRY COMPOSITION CONTAINING SAME

(71) Applicant: KCTECH CO., LTD., Gyeonggi-do (KR)

(72) Inventors: Nak Hyun CHOI, Gyeonggi-do (KR); Kwang Soo PARK, Gyeonggi-do (KR); Jung Yoon KIM, Gyeonggi-do (KR); Jun Ha HWANG, Gyeonggi-do (KR)

(73) Assignee: KCTECH CO., LTD., Gyeonggi-do (KR)

(21) Appl. No.: 16/331,137

(22) PCT Filed: Jun. 21, 2017
(86) PCT No.: PCT/KR2017/006497

§ 371 Date: Mar. 7, 2019

(30) Foreign Application Priority Data
Sep. 7, 2016 (KR) 10-2016-0114854

(51) Int. Cl. C09K 3/14

(52) U.S. Cl. CPC C09K 3/1436; C09G 1/02; C09K 3/1409

(57) ABSTRACT

The present invention relates to surface-modified colloidal ceria abrasive particles, a preparation method therefor, and a polishing slurry composition containing the same. According to one embodiment of the present invention, the surface-modified colloidal ceria abrasive particles comprise: colloidal ceria abrasive particles; and cerium atoms and hydroxyl groups (—OH) formed on the surface of the colloidal ceria abrasive particles.

### TECHNICAL FIELD

Example embodiments relate to surface-modified colloidal ceria abrasive particles, a preparation method thereof, and a polishing slurry composition containing the same.

### BACKGROUND ART

A chemical mechanical polishing (CMP) process refers to a process of contacting a semiconductor wafer surface with a polishing pad and smoothly performing polishing using a slurry containing an abrasive and various compounds during a rotation movement. CMP slurries may be classified based on a target to be polished. CMP slurries may be broadly classified into an insulating film polishing slurry for polishing an insulating film, for example, silicon nitride (Si₃N₄) and silicon oxide (SiO₂) that is an insulating layer, and a metal polishing slurry for polishing a metal layer, for example, a copper layer, a tungsten layer, an aluminum layer, and the like. For polishing of an oxide film, a solid content of abrasive particles is increased, a particle size is increased, a surface contact area is increased by mixing abrasive particles that are different in size, or abrasive particles complexed or doped with various metals are used. However, when the solid content or the size of abrasive particles is increased, it is vulnerable to surface defects of a film of a target to be polished and a unit price of polishing slurry increases. Also, when abrasive particles that are different in size are mixed and used or abrasive particles are complexed or doped with various metals, it is difficult to secure reproducibility in a manufacturing process and a polishing process.

### DISCLOSURE OF INVENTION

### Technical Subject

The present disclosure is to solve the foregoing problems, and an aspect of the present disclosure is to provide surface-modified colloidal ceria abrasive particles, a preparation method therefor, and a polishing slurry composition containing the same which may increase a contact area with a surface of an oxide film and may enhance an oxide film polishing performance.

However, the problems to be solved in the present disclosure are not limited to the foregoing problems, and other problems not mentioned herein would be clearly understood by one of ordinary skill in the art from the following description.

### Technical Solution

According to an aspect, there is provided surface-modified colloidal ceria abrasive particles including: colloidal ceria abrasive particles; and cerium atoms and hydroxyl groups (—OH) formed on a surface of the colloidal ceria abrasive particles.

The surface-modified colloidal ceria abrasive particles may be obtained by coating the surface of the colloidal ceria abrasive particles with the cerium atoms and hydroxyl groups (—OH); or by partially bonding the cerium atoms and hydroxyl groups (—OH) to the surface of the colloidal ceria abrasive particles.

The cerium atoms and hydroxyl groups (—OH) may be bonded to oxygen or cerium atoms present on the surface of the colloidal ceria abrasive particles.

The colloidal ceria abrasive particles may have a single size of 40 nm to 250 nm.

The surface-modified colloidal ceria abrasive particles may have a specific surface area of 15 m²/g to 100 m²/g.

The surface-modified colloidal ceria abrasive particles may have a spherical shape.

According to another aspect, there is provided a method of preparing surface-modified colloidal ceria abrasive particles, the method including: preparing a mixed solution by mixing and stirring colloidal ceria abrasive particles and a cerium precursor; preparing a reaction solution by adding a precipitant to the mixed solution and performing stirring; and performing hydrothermal synthesis of the reaction solution.

The cerium precursor may include at least one selected from the group consisting of nitrate of cerium, ammonium nitrate, sulfate, phosphate, chloride, carbonate and acetate.

The precipitant may include at least one selected from the group consisting of ammonium hydroxide (NH₄OH), sodium hydroxide, potassium hydroxide, ammonia water, and C1 to C4 alcohols.

The cerium precursor may have a molar concentration of 0.1 to 2.

The cerium precursor may have a molar concentration of 1 to 2.

A weight ratio of the ceria/cerium precursor may be in the range of 0.15 to 1.6.

A weight ratio of the ceria/cerium precursor may be in the range of 0.7 to 1.6.

The stirring may be performed at a speed of 200 rpm to 600 rpm under a temperature condition of 50° C. to 100° C. for a period of 30 minutes to 12 hours.

The hydrothermal synthesis may be performed under a temperature condition of 100° C. to 300° C. and a pressure condition of 20 bar to 50 bar for a period of 1 hour to 24 hours.

According to another aspect, there is provided a polishing slurry composition containing the surface-modified colloidal ceria abrasive particles.

### Effect

According to example embodiments, surface-modified colloidal ceria abrasive particles may increase a specific surface area and reactivity through a surface modification by introducing cerium atoms and hydroxyl groups (—OH) in a surface.

According to example embodiments, by a method of preparing surface-modified colloidal ceria abrasive particles, a specific surface area may be increased by increasing cerium atoms and hydroxyl groups (—OH) on a surface, and an oxide film high-speed polishing performance may be realized, unlike a method of preparing particles by complexing or doping ceria abrasive particles with various metals according to a related art.

According to example embodiments, in a polishing slurry composition containing surface-modified colloidal ceria abrasive particles, a specific surface area may be increased by cerium atoms on a surface of the surface-modified colloidal ceria abrasive particles, and a hydroxyl group (—OH) may react with a surface of an oxide film to accelerate a hydrolysis reaction of the surface of the oxide film, thereby increasing a polishing speed of the oxide film.

### BRIEF DESCRIPTION OF DRAWINGS

FIG. 1 is a diagram illustrating a chemical bonding state of a general colloidal ceria abrasive particle;

FIG. 2 is a diagram illustrating a chemical bonding state of a surface-modified colloidal ceria abrasive particle according to an example embodiment;

FIG. 3 is a flowchart illustrating a method of preparing surface-modified colloidal ceria abrasive particles according to an example embodiment;

FIG. 4 illustrates images of a colloidal ceria abrasive particle according to a comparative example and surface-modified colloidal ceria abrasive particles according to Examples 1 to 3;

FIG. 5 illustrates an X-ray diffraction (XRD) analysis result of the colloidal ceria abrasive particle according to the comparative example and surface-modified colloidal ceria abrasive particles according to Examples 1 to 3;

FIG. 6 illustrates transmission electron microscope (TEM) images of the colloidal ceria abrasive particle according to the comparative example and surface-modified colloidal ceria abrasive particles according to Examples 1 to 3; and

FIG. 7 is a graph showing an oxide film removal rate (RR) after polishing an oxide film using slurry compositions containing the colloidal ceria abrasive particle according to the comparative example and surface-modified colloidal ceria abrasive particles according to Examples 1 to 3.

### BEST MODE FOR CARRYING OUT THE INVENTION

Hereinafter, example embodiments of the present disclosure will be described in detail with reference to the accompanying drawings. When it is determined detailed description related to a related known function or configuration they may make the purpose of the present disclosure unnecessarily ambiguous in describing the present disclosure, the detailed description will be omitted here. Also, terminologies used herein are defined to appropriately describe the example embodiments and thus may be changed depending on a user, the intent of an operator, or a custom of a field to which the present disclosure pertains. Accordingly, the terminologies must be defined based on the following overall description of this specification. Like reference numerals illustrated in the drawings refer to like constituent elements throughout the specification.

Throughout the whole document, the term “comprises or includes” and/or “comprising or including” specify the presence of stated elements or components, but do not preclude the presence or addition of one or more other elements or components, unless mentioned otherwise.

Hereinafter, surface-modified colloidal ceria abrasive particles, a preparation method therefor, and a polishing slurry composition containing the same according to the present disclosure will be described in detail with reference to example embodiments and drawings. However, the present disclosure is not limited to the example embodiments and drawings.

According to an example embodiment, there is provided surface-modified colloidal ceria abrasive particles that include colloidal ceria abrasive particles; and cerium atoms and hydroxyl groups (—OH) formed on a surface of the colloidal ceria abrasive particles.

The hydroxyl group (—OH) may have a structure of —OH included in a substituent other than hydroxyl groups (—OH) as well as hydroxyl groups (hydroxyl), and may include, for example, a structure of —OH included in a carboxyl group (—COOH) or —CH═N—OH group.

The colloidal ceria abrasive particles of which the surface is modified with the cerium atoms and hydroxyl groups (—OH) may have a specific surface area increased by the cerium atoms on the surface of the colloidal ceria abrasive particles, and the hydroxyl groups (—OH) on the surface may react with a surface of an oxide film to accelerate a hydrolysis reaction of the surface of the oxide film, so that a polishing speed of the oxide film may increase.

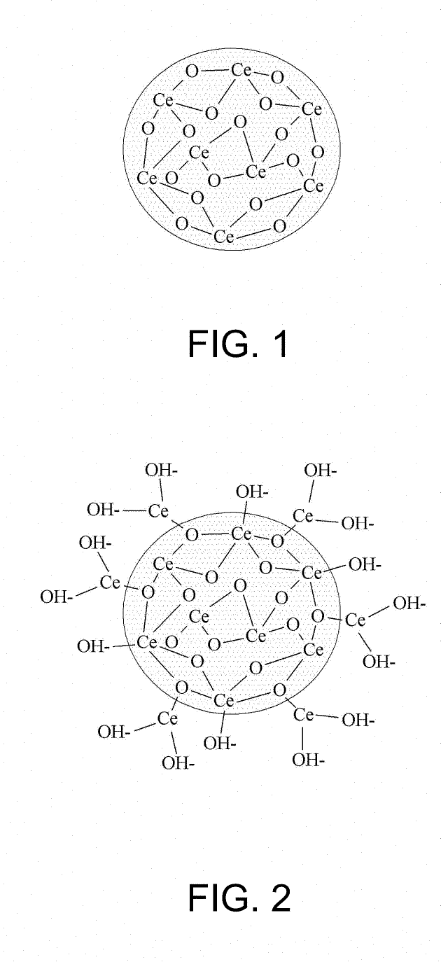

FIG. 1 is a diagram illustrating a chemical bonding state of a general colloidal ceria abrasive particle, and FIG. 2 is a diagram illustrating a chemical bonding state of a surface-modified colloidal ceria abrasive particle according to an example embodiment. Referring to FIGS. 1 and 2, in the surface-modified colloidal ceria abrasive particle, cerium atoms and hydroxyl groups (—OH) are bonded to a surface of the general colloidal ceria abrasive particle.

The surface-modified colloidal ceria abrasive particles may be obtained by coating the surface of the colloidal ceria abrasive particles with the cerium atoms and hydroxyl groups (—OH); or by partially bonding the cerium atoms and hydroxyl groups (—OH) to the surface of the colloidal ceria abrasive particles.

The cerium atoms and hydroxyl groups (—OH) may be bonded to oxygen or cerium atoms present on the surface of the colloidal ceria abrasive particles. The surface-modified colloidal ceria abrasive particles may be obtained by bonding a hydroxyl group (—OH) directly to cerium bonded to oxygen of the colloidal ceria abrasive particles; or bonding a hydroxyl group (—OH) directly to cerium of the colloidal ceria abrasive particles. Also, cerium atoms may be bonded to oxygen of the colloidal ceria abrasive particles.

The surface-modified colloidal ceria abrasive particles may be core-shell particles in which the colloidal ceria abrasive particles form a core and in which the cerium atoms and hydroxyl groups (—OH) on the surface of the colloidal ceria abrasive particles form a shell.

The colloidal ceria abrasive particles may have a single size of 40 nm to 250 nm. When the size of the colloidal ceria abrasive particles is less than 40 nm, the polishing speed may decrease. When the size of the colloidal ceria abrasive particles exceeds 250 nm, polishing may be excessively performed and it may be difficult to adjust dishing, surface defects and a polishing rate.

The surface-modified colloidal ceria abrasive particles may have a specific surface area of 15 m²/g to 100 m²/g. When the specific surface area is less than 15 m²/g, defects, such as scratches and orange peel appearances, may easily occur on a polished surface. When the specific surface area exceeds 100 m²/g, the polishing speed may not sufficiently increase due to a low degree of crystallinity of the abrasive particles.

The specific surface area may be measured by a Brunauer-Emmett-Teller (BET) method. For example, the specific surface area may be measured by a 6-point BET method according to a nitrogen gas adsorption-flow method using a porosimetry analyzer (Belsorp-II mini by Bell Japan Inc.).

The surface-modified colloidal ceria abrasive particles may have a spherical shape.

According to another example embodiment, there is provided a method of preparing surface-modified colloidal ceria abrasive particles, the method including: preparing a mixed solution by mixing and stirring colloidal ceria abrasive particles and a cerium precursor; preparing a reaction solution by adding a precipitant to the mixed solution and performing stirring; and performing hydrothermal synthesis of the reaction solution.

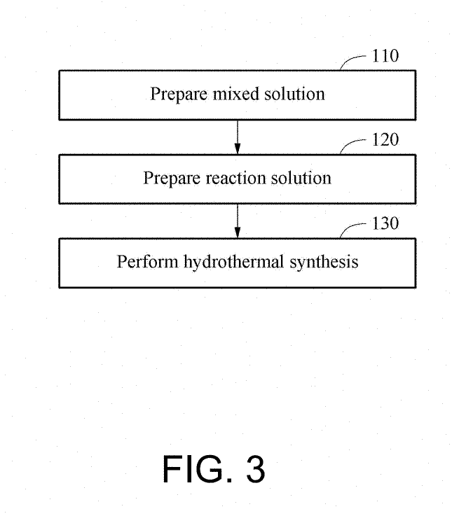

FIG. 3 is a flowchart illustrating a method of preparing surface-modified colloidal ceria abrasive particles according to an example embodiment. Referring to FIG. 3, the method of preparing surface-modified colloidal ceria abrasive particles includes step 110 of preparing a mixed solution, step 120 of preparing a reaction solution and step 130 of performing hydrothermal synthesis.

In step 110, colloidal ceria abrasive particles and a cerium precursor are mixed and stirred to prepare a mixed solution.

The cerium precursor may include at least one selected from the group consisting of nitrate of cerium, ammonium nitrate, sulfate, phosphate, chloride, carbonate and acetate. More specifically, the cerium precursor may include at least one selected from the group consisting of cerium(III) acetate, cerium(III) acetate hydrate, cerium(III) acetylacetonate, cerium(III) acetylacetonate hydrate, cerium(III) carbonate, cerium(III) carbonate hydrate, cerium(IV) hydroxide, cerium(III) fluoride, cerium(IV) fluoride, cerium(III) chloride, cerium(III) chloride heptahydrate, cerium(III) bromide, cerium(III) iodide, cerium(III) nitrate, cerium(IV) nitrate, di-ammonium cerium(IV) nitrate, cerium(III) nitrate hexahydrate, cerium(III) Phosphate, cerium(III) Phosphate Hydrate, cerium(III) oxalate, cerium(III) oxalate hydrate, cerium(III) sulfate, cerium(III) sulfate hydrate, cerium(IV) sulfate, and cerium(IV) sulfate hydrate.

The stirring may be performed at a speed of 200 rpm to 600 rpm under a temperature condition of 50° C. to 100° C. for a period of 30 minutes to 12 hours. When the stirring is performed at a temperature lower than 50° C. and a speed less than 200 rpm for less than 30 minutes, the cerium precursor may not be uniformly formed on the colloidal ceria abrasive particles. Also, considering a shape of a reactor and reaction stability, the stirring may desirably be performed in a range that does not exceed 100° C., 600 rpm and 12 hours.

A molar concentration of the cerium precursor and a weight ratio of ceria/cerium precursor may be used as a major factor in determining a particle size of a powder by controlling crystal growth and nucleation of the surface modified colloidal ceria during a precipitation reaction. For example, a concentration of the cerium precursor may be maintained at a certain level at the beginning of a reaction, and when a surface-modified colloidal ceria powder as a product starts to precipitate, the concentration of the cerium precursor may sharply decrease. Here, when the concentration of the cerium precursor that is a raw material is low, crystal growth may not be sufficiently achieved after nucleation. When the concentration of the cerium precursor is high, powders may have different particle sizes and the particle size distribution may be broadened, due to uneven nucleation and crystal growth.

For example, the cerium precursor may have a molar concentration of 0.1 to 2. When the molar concentration of the cerium precursor exceeds 2, ceria particles may aggregate. A slurry composition containing surface-modified colloidal ceria abrasive particles prepared with the cerium precursor having the molar concentration of 0.1 to 2 may increase an oxide film polishing rate.

For example, the cerium precursor may have a molar concentration of 1 to 2. When the molar concentration of the cerium precursor is 1 or greater and 2 or less, the oxide film polishing rate may increase and polishing planarization may also be enhanced.

The weight ratio of the ceria/cerium precursor may be in the range of 0.15 to 1.6. A slurry composition containing surface-modified colloidal ceria abrasive particles prepared with the weight ratio of the ceria/cerium precursor in the range of 0.15 to 1.6 may increase the oxide film polishing rate. When the weight ratio of the ceria/cerium precursor is out of the range, a surface modification effect may not be expected.

The weight ratio of the ceria/cerium precursor may be in the range of 0.7 to 1.6. When the weight ratio of the ceria/cerium precursor is 0.7 or greater and 1.6 or less, the oxide film polishing rate may increase and polishing planarization may also be enhanced.

In step 120, a precipitant is added to the mixed solution of the colloidal ceria abrasive particles and the cerium precursor and stirring is performed, to prepare a reaction solution.

The precipitant may include at least one selected from the group consisting of ammonium hydroxide (NH₄OH), sodium hydroxide, potassium hydroxide, ammonia water, and C1 to C4 alcohols. The precipitant may be added to introduce a hydroxyl group (—OH) in the surface of the colloidal ceria abrasive particles.

The stirring may be performed at a speed of 200 rpm to 600 rpm under a temperature condition of 50° C. to 100° C. for a period of 30 minutes to 12 hours. When the stirring is performed at a temperature lower than 50° C. and a speed less than 200 rpm for less than 30 minutes, the cerium precursor may not be uniformly formed on the colloidal ceria abrasive particles. Also, considering a shape of a reactor and reaction stability, the stirring may desirably be performed in a range that does not exceed 100° C., 600 rpm and 12 hours.

By adding the precipitant, pH of the reaction solution may be in the range of 8 to 12. The pH of the reaction solution may be adjusted within the range of 8 to 12, and accordingly a surface-modified colloidal ceria power uniformly including surface-modified colloidal ceria abrasive particles with various shapes, for example, a spherical shape, a square shape, a needle shape, a plate shape, and the like, and sizes may be easily obtained. Thus, by the above method, surface-modified colloidal ceria abrasive particles having a desired shape and particle size without a change in a synthesis process with various difficulties, and a surface-modified colloidal ceria powder including the surface-modified colloidal ceria abrasive particles may be easily obtained at a high yield.

For desired pH, at least one pH adjuster selected from the group consisting of ammonia, ammonium methyl propanol (AMP), tetra methyl ammonium hydroxide (TMAH), ammonium hydroxide, potassium hydroxide, sodium hydroxide, magnesium hydroxide, rubidium hydroxide, cesium hydroxide, sodium hydrogen carbonate, sodium carbonate, and imidazole may be further included.

In step 130, hydrothermal synthesis of the reaction solution prepared by adding the precipitant to the mixed solution including the colloidal ceria abrasive particles and the cerium precursor and performing stirring is performed.

The hydrothermal synthesis may be performed under a temperature condition of 100° C. to 300° C. and a pressure condition of 20 bar to 50 bar for a period of 1 hour to 24 hours. When the hydrothermal synthesis is performed at a temperature lower than 100° C., a reaction time may increase. When the hydrothermal synthesis is performed at a temperature higher than 300° C., a reaction pressure may excessively increase. In terms of the reaction pressure, the hydrothermal synthesis may desirably be performed under an operating condition of 20 bar to 50 bar based on risk of a reaction operating condition and reaction time. When the reaction time is less than 1 hour, a yield may be low. When the reaction time is greater than 24 hours, it is economically disadvantageous without special advantage.

For example, a process (not shown) of washing the surface-modified colloidal ceria abrasive particles using deionized water may be further performed after the hydrothermal synthesis.

The surface-modified colloidal ceria abrasive particles may have a specific surface area of 15 m²/g to 100 m²/g. When the specific surface area is less than 15 m²/g, defects, such as scratches and orange peel appearances, may easily occur on a polished surface. When the specific surface area exceeds 100 m²/g, the polishing speed may not sufficiently increase due to a low degree of crystallinity of the abrasive particles.

The specific surface area of the surface-modified colloidal ceria abrasive particles may increase based on an increase in the weight ratio of the ceria/cerium precursor. When the weight ratio of the ceria/cerium precursor is in the range of 0.15 to 0.5, the specific surface area may be in the range of 15 m²/g to 30 m²/g. When the weight ratio of the ceria/cerium precursor is in the range of 0.5 to 1.4, the specific surface area may be in the range of 30 m²/g to 45 m²/g. When the weight ratio of the ceria/cerium precursor is in the range of 1.4 to 1.6, the specific surface area may be in the range of 45 m²/g to 100 m²/g.

According to another example embodiment, there is provided a polishing slurry composition containing the surface-modified colloidal ceria abrasive particles.

In the polishing slurry composition containing the surface-modified colloidal ceria abrasive particles, cerium atoms and hydroxyl groups (—OH) on the surface of the surface-modified colloidal ceria abrasive particles may react with a surface of an oxide film to accelerate a hydrolysis reaction of the surface of the oxide film, thereby increasing a polishing speed of the oxide film.

The surface-modified colloidal ceria abrasive particles may be present in an amount of 1 to 10 wt % in the polishing slurry composition. When the amount of the surface-modified colloidal ceria abrasive particles is less than 1 wt %, the polishing speed may decrease. When the amount of the surface-modified colloidal ceria abrasive particles exceeds 10 wt %, a defect may occur due to abrasive particles.

The polishing slurry composition may further include at least one polishing additive selected from the group consisting of an organic acid, a cationic surfactant, a nonionic surfactant, and a pH adjuster.

The organic acid may include at least one selected from the group consisting of picolinic acid, nicotinic acid, isonicotinic acid, fusaric acid, dinicotinic acid, dipiconilic acid, lutidinic acid, quinolic acid, glutamic acid, alanine, glycine, cystine, histidine, asparagine, guanidine, hydrazine, ethylenediamine, formic acid, acetic acid, benzoic acid, oxalic acid, succinic acid, malic acid, maleic acid, malonic acid, citric acid, lactic acid, tricarballyic acid, tartaric acid, aspartic acid, glutaric acid, adipic acid, suberic acid, fumaric acid, phthalic acid, pyridinecarboxylic acid, and salts thereof.

The organic acid may be present in an amount of 10 wt % to 90 wt % in the polishing additive. When the amount of the organic acid is less than 10 wt %, a low polishing characteristic may be shown. When the amount of the organic acid exceeds 90 wt %, a substrate surface defect may increase.

The cationic surfactant may be at least one selected from the group consisting of primary to tertiary amine salts, a quaternary ammonium salt, a phosphonium salt and a sulfonium salt. The primary to tertiary amine salts may be at least one selected from the group consisting of methylamine, butylamine, ethanolamine, isopropylamine, diethanolamine, triethanolamine, dipropylamine, ethylenediamine, propanediamine, triethylenetetramine, tetraethylenepentamine, 2-amino-2-methyl-propanol (AMP), diethanolamine, 3-amino-1-propanol, 2-amino-1-propanol, 1-amino-2-propanol, and 1-amino-pentanol. The quaternary ammonium salt may be at least one selected from the group consisting of Aquard, Decamine, Sapamin MS, Benzalkonium chloride, Hyamine, Repellat, Emcol E-607, Zelan A, Velan PF and Isotan Q-16.

The nonionic surfactant may include at least one selected from the group consisting of polyethylene glycol, polypropylene glycol, polyvinyl pyrrolidone, polyethylene oxide, polypropylene oxide, polyalkyl oxide, polyoxyethylene oxide and polyethylene oxide-propylene oxide copolymer.

The pH adjuster may include one selected from the group consisting of ammonia, ammonium methyl propanol (AMP), tetra methyl ammonium hydroxide (TMAH), potassium hydroxides, sodium hydroxide, magnesium hydroxide, rubidium hydroxide, cesium hydroxide, sodium hydrogen carbonate, sodium carbonate, triethanolamine, tromethamine, niacinamide, nitric acid, sulfuric acid, phosphoric acid, hydrochloric acid, acetic acid, citric acid, glutaric acid, gluconic acid, formic acid, lactic acid, malic acid, malonic acid, maleic acid, oxalic acid, phthalic acid, succinic acid, and tartaric acid, and combinations thereof.

The pH adjuster may adjust a degree of dispersion of coated abrasive particles by adjusting pH of the polishing additive, and may be present in an amount of 0.01 wt % to 1 wt % in the polishing additive.

Hereinafter, the present disclosure will be described in detail with reference to examples and comparative example. However, the technical idea of the present disclosure is not limited or restricted to the examples and comparative example.

### EXAMPLES

### Example 1

Colloidal ceria abrasive particles with a size of 60 nm as abrasive particles, and cerium ammonium nitrate as a cerium precursor were mixed at a weight ratio of 0.15 (colloidal ceria abrasive particles/cerium precursor) and stirred at 70° C. and 300 rpm for 1 hour. Next, ammonium hydroxide was added as a precipitant, and stirring was performed at 70° C. and 300 rpm for 1 hour, to prepare a reaction solution with pH 10. Hydrothermal synthesis of the reaction solution was performed at 250° C. and 30 bar for 12 hours, and washing with deionized water was performed, to prepare surface-modified colloidal ceria abrasive particles.

### Example 2

Surface-modified colloidal ceria abrasive particles were prepared using the same method as in Example 1 except that the weight ratio of colloidal ceria abrasive particles/cerium precursor is 0.76 in Example 1.

### Example 3

Surface-modified colloidal ceria abrasive particles were prepared using the same method as in Example 1 except that the weight ratio of colloidal ceria abrasive particles/cerium precursor is 1.52 in Example 1.

### Comparative Example

A colloidal ceria abrasive particle having a surface that is not modified by a cerium precursor was prepared.

Table 1 shows a specific surface area based on a weight ratio of colloidal ceria abrasive particles/cerium precursor in Examples 1 to 3 and the comparative example.

TABLE 1

| | Weight ratio | Specific |
|---|---|---|
| | of CeO₂/Ce | surface |
| | precursor | area (m²/g) |
| Comparative example | — | 14.235 |
| Example 1 | 0.15 | 17.652 |
| Example 2 | 0.76 | 34.717 |
| Example 3 | 1.52 | 52.046 |

Referring to Table 1, it may be found that a specific surface area of the surface-modified colloidal ceria abrasive particles of Examples 1 to 3 is greater than that of the colloidal ceria abrasive particle of the comparative example, and that the specific surface area of the surface-modified colloidal ceria abrasive particles of Examples 2 and 3 in which the weight ratio of colloidal ceria abrasive particles/cerium precursor is greater than the weight ratio of 0.15 in Example 1 is greater than that of Example 1.

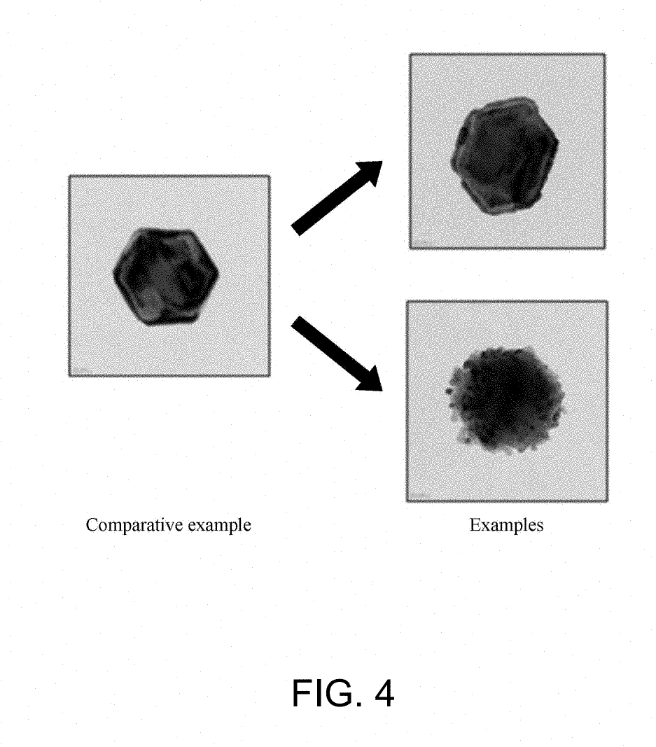

FIG. 4 illustrates images of a colloidal ceria abrasive particle according to a comparative example and surface-modified colloidal ceria abrasive particles according to Examples 1 to 3. As shown in FIG. 4, it may be confirmed that the abrasive particle of Example 1 changes from a square shape to a spherical shape in comparison to the comparative example, and that the surface-modified colloidal ceria abrasive particle of Example 1 has a core-shell shape.

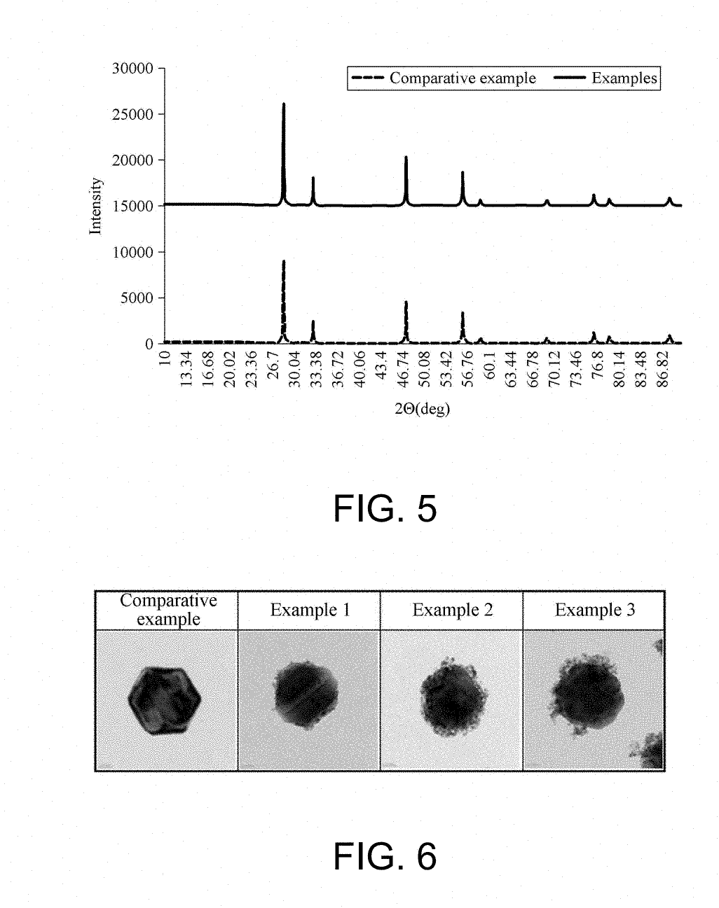

FIG. 5 illustrates an X-ray diffraction (XRD) analysis result of the colloidal ceria abrasive particle according to the comparative example and surface-modified colloidal ceria abrasive particles according to Examples 1 to 3. The same X-ray diffraction peaks are shown in the comparative example and examples, and it may be confirmed that ceria particles are formed despite surface modification.

FIG. 6 illustrates transmission electron microscope (TEM) images of the colloidal ceria abrasive particle according to the comparative example and surface-modified colloidal ceria abrasive particles according to Examples 1 to 3. Referring to FIG. 6, it may be confirmed that colloidal ceria abrasive particle according to the comparative example has a hexagonal shape, whereas the surface-modified colloidal ceria abrasive particles of Examples 1 to 3 have a core-shell shape similar to a spherical shape.

An oxide film water was polished using a polishing slurry composition containing the colloidal ceria abrasive particle according to the comparative example and polishing slurry compositions containing the surface-modified colloidal ceria abrasive particles of Examples 1 to 3 under the following polishing conditions.

<Polishing Conditions>
1. Polishing equipment: AP-300(CTS)
2. Pad: IC 1000
3. Polishing time: 60S
4. Platen speed: 110 rpm
5. Spindle speed: 108 rpm
6. Wafer pressure: 3.5 psi
7. Slurry flow rate: 200 ml/min
8. Wafer: PE-TEOS

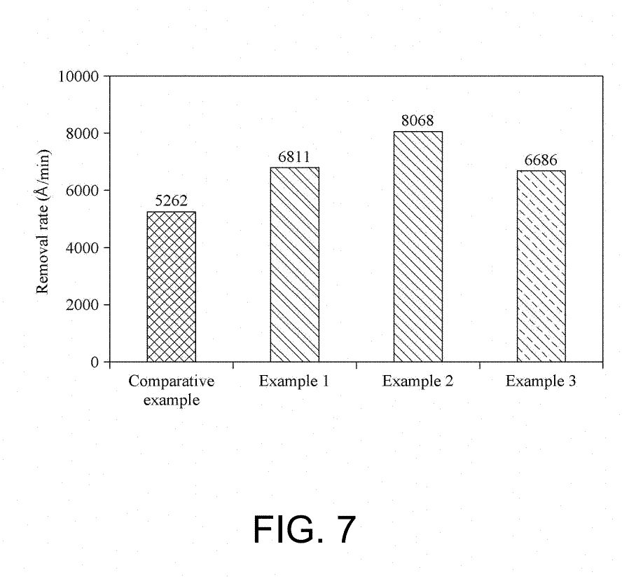

FIG. 7 is a graph showing an oxide film removal rate (RR) after polishing an oxide film using slurry compositions containing the colloidal ceria abrasive particle according to the comparative example and surface-modified colloidal ceria abrasive particles according to Examples 1 to 3. Referring to FIG. 7, a polishing slurry composition containing the colloidal ceria abrasive particles according to the comparative example of FIG. 7 has an oxide film RR of 5262 Å. Also, polishing slurry compositions containing the surface-modified colloidal ceria abrasive particles according to Examples 1 to 3 have oxide film RRs of 6811 Å, 8068 Å and 6686 Å, respectively, and thus it may be confirmed that polishing is performed at 6500 Å or greater.

It may be confirmed that in the polishing slurry compositions containing the surface-modified colloidal ceria abrasive particles according to Examples 1 to 3, cerium atoms and hydroxyl groups (—OH) on the surface of the surface-modified colloidal ceria abrasive particles react with a surface of the oxide film to accelerate a hydrolysis reaction of the surface of the oxide film, thereby increasing a polishing speed of the oxide film.

Although a few example embodiments of the present disclosure have been shown and described, the present disclosure is not limited to the described example embodiments. Instead, it would be appreciated by those skilled in the art that changes may be made to these example embodiments without departing from the principles and spirit of the present disclosure, the scope of which is defined by the claims and their equivalents.

1. Surface-modified colloidal ceria abrasive particles comprising:
colloidal ceria abrasive particles; and
cerium atoms and hydroxyl groups (—OH) formed on a surface of the colloidal ceria abrasive particles.

2. The surface-modified colloidal ceria abrasive particles of claim 1, wherein the surface-modified colloidal ceria abrasive particles are obtained by coating the surface of the colloidal ceria abrasive particles with the cerium atoms and hydroxyl groups (—OH); or by partially bonding the cerium atoms and hydroxyl groups (—OH) to the surface of the colloidal ceria abrasive particles.

3. The surface-modified colloidal ceria abrasive particles of claim 1, wherein the cerium atoms and hydroxyl groups (—OH) are bonded to oxygen or cerium atoms present on the surface of the colloidal ceria abrasive particles.

4. The surface-modified colloidal ceria abrasive particles of claim 1, wherein the colloidal ceria abrasive particles have a single size of 40 nm to 250 nm.

5. The surface-modified colloidal ceria abrasive particles of claim 1, wherein the surface-modified colloidal ceria abrasive particles have a specific surface area of 15 m²/g to 100 m²/g.

6. The surface-modified colloidal ceria abrasive particles of claim 1, wherein the surface-modified colloidal ceria abrasive particles have a spherical shape.

7. A method of preparing surface-modified colloidal ceria abrasive particles, the method comprising:
preparing a mixed solution by mixing and stirring colloidal ceria abrasive particles and a cerium precursor;
preparing a reaction solution by adding a precipitant to the mixed solution and performing stirring; and
performing hydrothermal synthesis of the reaction solution.

8. The method of claim 7, wherein the cerium precursor comprises at least one selected from the group consisting of nitrate of cerium, ammonium nitrate, sulfate, phosphate, chloride, carbonate and acetate.

9. The method of claim 7, wherein the precipitant comprises at least one selected from the group consisting of ammonium hydroxide (NH₄OH), sodium hydroxide, potassium hydroxide, ammonia water, and C1 to C4 alcohols.

10. The method of claim 7, wherein the cerium precursor has a molar concentration of 0.1 to 2.

11. The method of claim 7, wherein the cerium precursor has a molar concentration of 1 to 2.

12. The method of claim 7, wherein a weight ratio of the ceria/cerium precursor is in the range of 0.15 to 1.6.

13. The method of claim 7, wherein a weight ratio of the ceria/cerium precursor is in the range of 0.7 to 1.6.

14. The method of claim 7, wherein the stirring is performed at a speed of 200 rpm to 600 rpm under a temperature condition of 50° C. to 100° C. for a period of 30 minutes to 12 hours.

15. The method of claim 7, wherein the hydrothermal synthesis is performed under a temperature condition of 100° C. to 300° C. and a pressure condition of 20 bar to 50 bar for a period of 1 hour to 24 hours.

16. A polishing slurry composition containing the surface-modified colloidal ceria abrasive particles of claim 1.
